(19) United States
(12) Patent Application Publication
(10) Pub. No.: US 2010/0003471 A1
(43) Pub. Date: Jan. 7, 2010

(54) Transfer Tape

(75) Inventor: Yusuke Yonetsu, Tokyo (JP)

Correspondence Address: The Marbury Law Group, PLLC, 11800 SUNRISE VALLEY DRIVE, SUITE 1000, RESTON, VA, 20191, US

(73) Assignee: PLUS STATIONERY CORPORATION, Tokyo (JP)

(21) Appl. No.: 12/486,329

(22) Filed: Jun. 17, 2009

(30) Foreign Application Priority Data
Jul. 2, 2008 (JP) 2008-173944

(51) Int. Cl. B32B 3/10

(52) U.S. Cl. 428/195.1

(57) ABSTRACT

The invention is to provide a transfer tape which includes an opacifying layer having a high opacifying effect of a pattern, and according to the invention, there is provided a transfer tape 1 comprising a base material layer 2 and a coating film layer 7 and adapted to transfer the coating film layer 7 on to a surface of a transfer object by a coating film transfer device 50, wherein the coating film layer 7 comprises a pattern layer 42 on which an opacifying pattern shape is printed, and wherein a pattern shape of the pattern layer 42 is such that a plurality of alphabetical characters are arranged obliquely inclined relative to a longitudinal direction of the transfer tape, and the coating film layer 7 comprises an ink layer 32 where pigments are contained in a medium, the ink layer 32 and the pattern layer 42 being laminated in such a manner that the ink layer 32 is positioned on a front surface side, while the pattern layer 42 is positioned on a rear surface side of the coating film layer.

### CROSS-REFERENCE TO RELATED APPLICATIONS

This application is based upon and claims the benefit of priority from the prior Japanese Patent Application No. 2008-173944, filed on Jul. 2, 2008; the entire contents of which are incorporated herein by reference.

### BACKGROUND OF THE INVENTION

1. Technical Field

The present invention relates to a transfer tape for use in a coating film transfer device.

2. Background Art

A coating film transfer device is a stationery tool for use in applying glue to a predetermined position on an envelope or correcting an erroneously written letter on a document and then constitutes one of stationery items which are indispensable to office work.

A most popular coating film transfer device is a coating film transfer device for a correcting tape which is used to conceal an erroneously written character by transferring a piece of white film to a portion where the erroneously written character exists, so that a correct character can be written on the white film so applied.

However, when a white film is transferred on to a piece of thin paper using a correcting tape transfer device like one described above, since the white film transmits light, there has been caused a problem that a character written in a position which is concealed by the white film can be read when the piece of paper or particularly the portion thereon where the white film is transferred is seen from a back side thereof while the paper is held to the light from a lamp such as a fluorescent lamp.

In addition, in recent years, in conjunction with the introduction of an Act on the Protection of Personal Information, business enterprises as well as individuals are sensitive to handling information regarding individuals, and documents containing such individuals' personal information are disposed of using a method of shredding or a method in which portions on documents where individuals' information is written are treated with or concealed by transfer tapes, seals or marking ink.

As a proposed method for concealing individuals' personal information using a coating film transfer device like the one described above or concealing written information under the white film, Japanese Unexamined Patent Publication No. 11-343467 proposes a technique for preventing what is concealed by a white film from being read from a back side of the white film by providing a concealing or opacifying layer on the back side of the white film.

In this patent document, as shapes of patterns which are printed on the opacifying layer, the following patterns are proposed; a pattern in which vertical lines of uniform width are arranged, a pattern in which vertical lines of different widths are arranged, a stripe pattern, a polka-dot pattern in which polka dots of the same size are arranged and a polka-dot pattern in which polka dots of different sizes are arranged. Furthermore, there are proposed additional pattern shapes including a pattern in which alphabetical and Japanese KATAKANA characters are regularly arranged into a matrix.

With these pattern shapes designed for the conventional transfer tapes, since the lines, polka dots and characters are arranged regularly, blank portions which constitute portions on the transfer tapes other than where those patterns are provided are also arranged regularly as a result, leading to a problem that the intended concealment cannot be attained depending upon sizes in point of characters or the like.

In addition, in fabrication of transfer tapes, since a large sheet on which a pattern is printed is cut into strips for fabrication of tapes, depending upon where to cut, there may be produced a transfer tape which has a large area of blank portions like those described above, leading to a problem that the concealing or opacifying effect becomes uneven depending upon where to cut.

### SUMMARY OF THE INVENTION

The present invention has been made in view of the problems inherent in the related art, and an object thereof is to provide a transfer tape which includes an opacifying layer of a pattern shape having a high opacifying effect.

According to an aspect of the invention, there is provided a transfer tape comprising a base material layer and a coating film layer and adapted to transfer the coating film layer on to a surface of a transfer object by a coating film transfer device, wherein the coating film layer comprises a pattern layer on which an opacifying pattern shape is printed, and a pattern shape of the pattern layer is such that a plurality of alphabetical characters are arranged obliquely inclined relative to a longitudinal direction of the transfer tape.

In addition, in the invention, the coating film layer comprises an ink layer where pigments are contained in a medium, the ink layer and the pattern layer being laminated in such a manner that the ink layer is positioned on a front surface side, while the pattern layer is positioned on a rear surface side of the coating film layer.

According to the aspect of the invention, it becomes possible to provide the transfer tape which includes the opacifying layer of the pattern shape having the high opacifying effect.

### BRIEF DESCRIPTION OF THE DRAWINGS

FIG. 1 is a sectional view of a transfer tape according to the invention, and FIG. 2 is a drawing which illustrates pattern shapes for use on the transfer tape according to the invention. In addition, FIG. 3 is a drawing which illustrates a state in which the transfer tape according to the invention is incorporated in a coating film transfer device for use, and FIG. 4 is a drawing which illustrates for comparison pattern shapes for use on a conventional transfer tape.

### DESCRIPTION OF THE PREFERRED EMBODIMENT

A transfer tape 1 which constitutes a best mode for carrying out the invention comprises a base material layer 2 and a coating film layer 7 and is adapted to transfer the coating film layer 7 on to a surface of a transfer object by a coating film transfer device 50. In the transfer tape 1, the coating film layer 7 includes a pattern layer 42 on which a concealing or opacifying pattern is printed, and the pattern printed on the pattern layer 42 is such that a plurality of alphabetical characters are arranged obliquely inclined relative to a longitudinal direction of the transfer tape 1.

In addition, the coating film layer 7 includes an ink layer 32 in which pigments are contained in a medium, and the ink layer 32 and the pattern layer 42 are laminated in such a manner that the ink layer 32 is positioned on a front surface side, while the pattern layer 42 is positioned on a rear surface side of the coating film layer 7.

Hereinafter, a transfer tape 1 according to an embodiment of the invention will be described in detail based on the accompanying drawings.

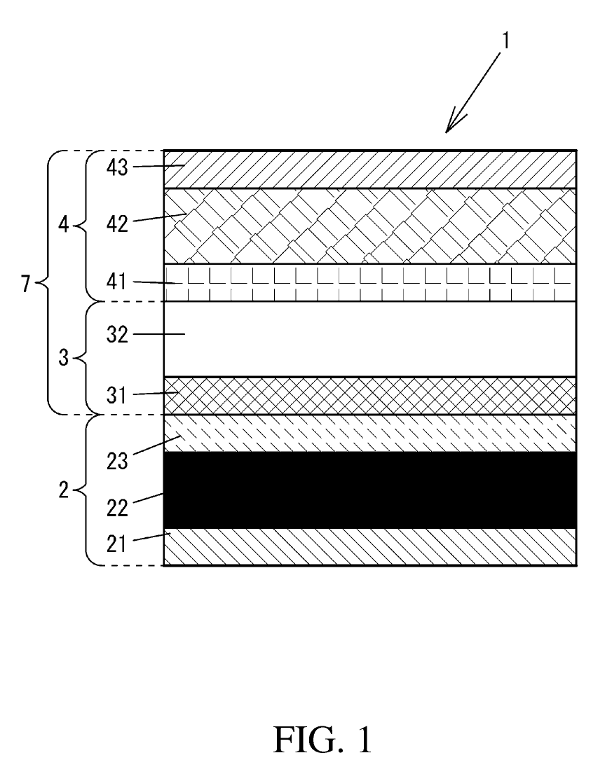

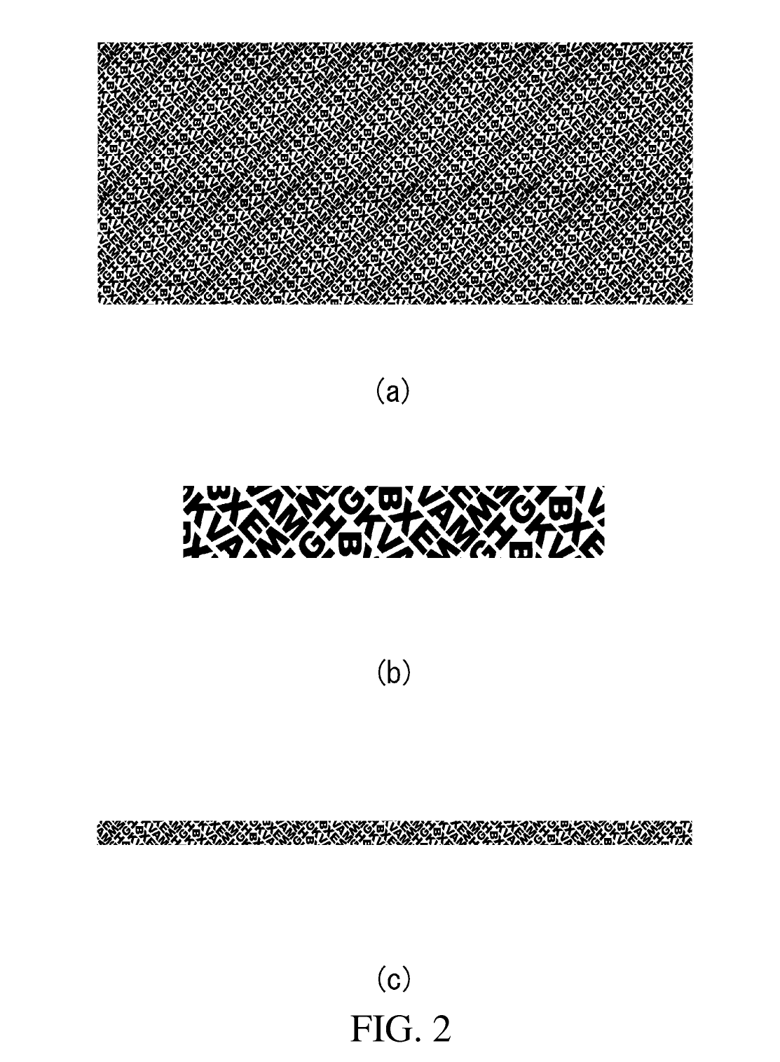

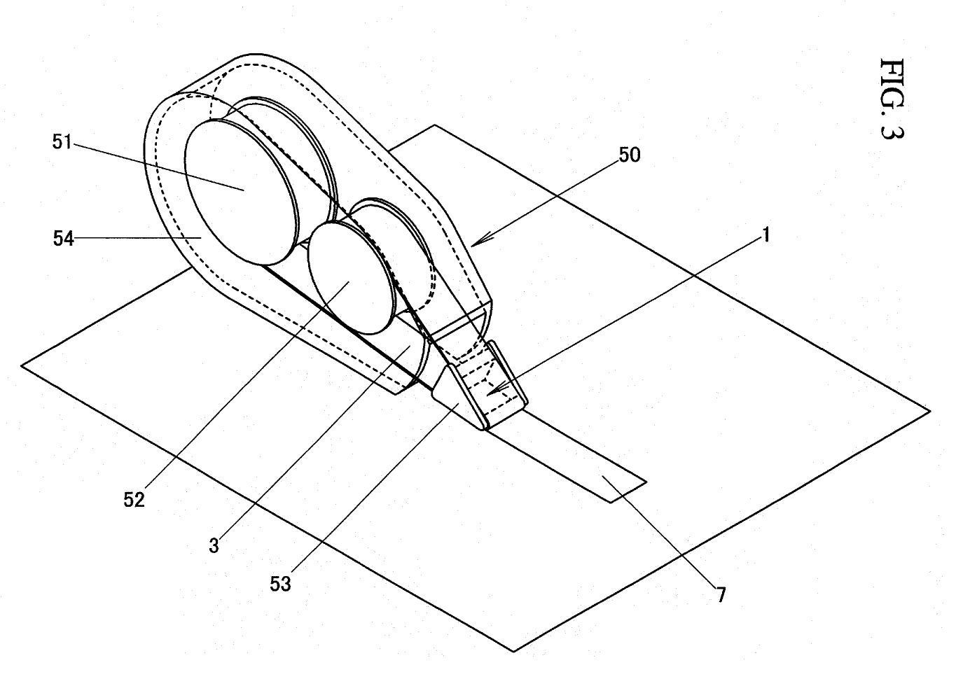

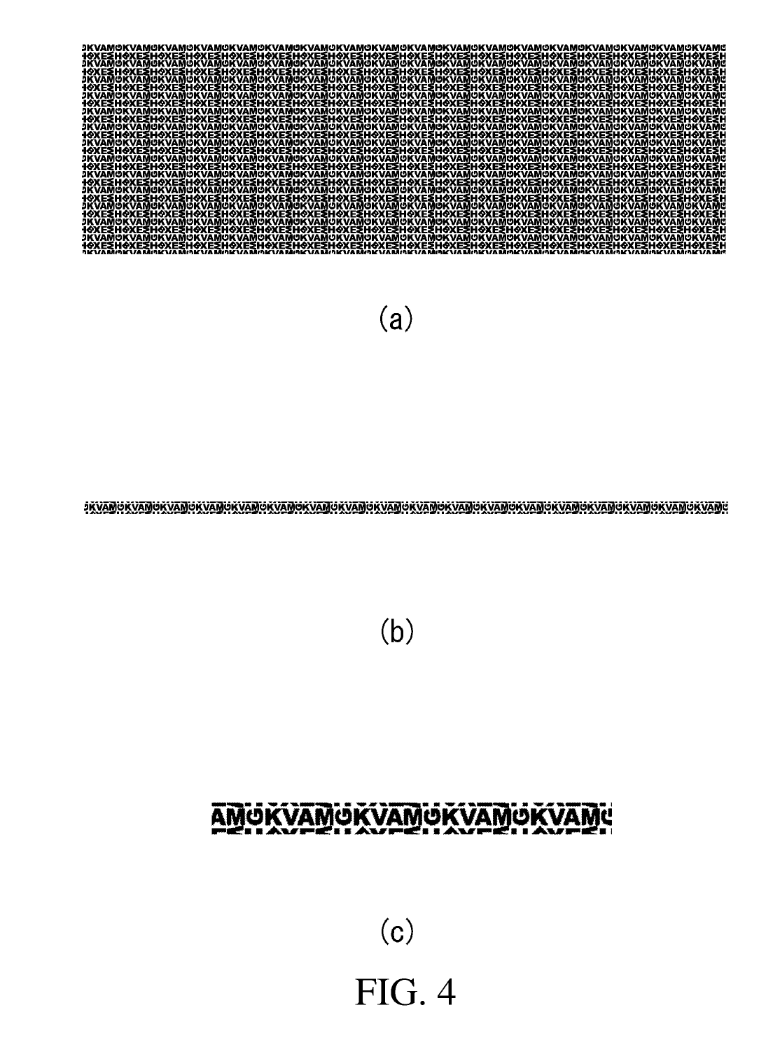

As is shown in FIG. 1, a transfer tape 1 of the embodiment is formed by laminating a base material layer 2, an anchor layer 3 and an opacifying layer 4 one on another. In addition, by the transfer tape 1 being press transferred on to a surface of a transfer object by a coating film transfer device, the anchor layer 3 and the opacifying layer 4 are transferred on to a surface of a transfer object as a coating film layer 7, so as to opacify a character or characters written on the transfer object.

In addition, the transfer tape 1 is fabricated by cutting a large sheet in which a base layer 2, an anchor layer 3 and an opacifying layer 4 are laminated one on another is cut or shredded into a thin and long tape shape, and the tapes so cut are incorporated for use into coating film transfer devices piece by piece as a transfer tape 1.

In addition, the base material layer 2 is made up of a base material 22, and a primary separation layer 21 and a secondary separation layer 23 which are laminated on a front side and a rear side of the base 22, respectively. This primary separation layer 21 is a layer of a release agent which is formed to separate a secondary adhesive layer 43 which constitutes a topmost layer from the base material layer 2 when the transfer tape 1 is wound on to a feed bobbin of the coating film transfer device, which will be described later, and is formed by a silicone resin. Additionally, the base material 22 constitutes a robust layer made up of a resin film of polyethylene terephthalate (PET). In addition, the secondary separation layer 23 is a layer of a release agent which is formed to separate a primary adhesive layer 31 of the anchor layer 3, which will be described later, from the base material layer 2 and is formed by a silicone resin.

The base material layer 2 is a layer for holding and protecting the anchor layer 3 and the opacifying layer 4 which are soft and brittle and constitutes a layer that is taken up by a take-up bobbin after the transfer tape 1 has been fed to transfer the coating film layer 7 on to a transfer object when the transfer tape 1 is transferred by the use of the coating film transfer device.

In addition, the anchor layer 3 is made up of the ink layer 32 and the primary adhesive layer 31, and this primary adhesive layer 31 is such as to be formed between the ink layer 32 and the secondary separation layer 23. This ink layer 32 is a layer which is formed by a medium and, for example, white colored pigments which are contained in the medium, and the first adhesive layer 31 is a layer of an acryl-based pressure sensitive adhesive and constitutes a layer for bonding the base material layer 2 and the anchor layer 3 together.

Furthermore, the opacifying layer 4 is made up of a pattern layer 42 on which a pattern is printed, a transparent layer 41 which is interposed between the pattern layer 42 and the anchor layer 3 and the secondary adhesive layer 43 which is laminated on the pattern layer 42. The pattern layer 42 is made up of a medium material and colored pigments which form a pattern printed on the medium material. In addition, the transparent layer 41 is a layer formed from a resin for separating the ink layer 32 of the anchor layer 3 from the pattern layer 42. Additionally, the secondary adhesive layer 43 is a layer made of an acryl-based pressure-sensitive adhesive and constitutes a layer for bonding the coating film layer 7 on to a surface of a transfer object.

A method of printing a pattern on the medium material to form the pattern on the pattern layer 42 makes use of known printing techniques such as letterpress printing, offset printing, gravure printing and the like.

The shape of the pattern printed on the pattern layer 42 is, as is shown in FIG. 2A and FIG. 2B which is an enlarged view showing part of a pattern shown in FIG. 2A, a shape in which 6-point capital alphabetical characters in 6-point which are different in orientation and inclination are arranged inclined obliquely at equal intervals. Here, in general, one point represents a unit of measurement for type sizes and spacing and measures 1/72 inch. Assuming that one inch is 25 mm, one point represents a type size and spacing of 0.35 mm, and hence, six points represent a type size and spacing of 2.1 mm.

In this embodiment, while the 6-point capital alphabetical characters are arranged inclined obliquely, depending upon sizes of characters written on transfer objects, characters in sizes of 30 to 80% of the width of a tape may be used, and hence, the invention is not limited to the use of 6-point characters. Due to sizes of characters used on business documents being generally in the range of 10 points to 12 points, in the invention, the 6-point capital alphabetical characters are used to delete or conceal characters in those sizes.

In the transfer tape 1, with the primary separation layer 21 of the base material layer 2 made to constitute a lowermost layer, the base material 22 is laminated on the primary separation layer 21, the secondary separation layer 23 is laminated on the base material 22, the primary adhesive layer 31 of the anchor layer 3 is laminated on the secondary separation layer 23, the ink layer 32 is laminated on the primary adhesive layer 31, the transparent layer 41 of the opacifying layer 4 is laminated on the ink layer 32, the pattern layer 42 is laminated on the transparent layer 41, the pattern layer 42 is laminated on the transparent layer 41, and the secondary adhesive layer 43 is laminated on the pattern layer 42 as a topmost layer. In addition, the transfer tape 1 is fabricated by cutting a sheet made up of the layers described above into a thin, long tape shape as is shown in FIG. 2C.

In addition, the transfer tape 1 of the embodiment is to be transferred on to a surface of a transfer object by the coating film transfer device 50 as is shown in FIG. 3. The coating film transfer device 50 is made up of a supply bobbin 51 on which the transfer tape 1 is wound, a take-up bobbin 52 on to which only the base material layer 2 is taken up, a transfer head 53 for press transferring the coating film layer 7 on to the surface of the transfer object, and a cover member 54.

In this coating film transfer device 50, the supply bobbin 51 and the take-up bobbin 52 are rotatably attached to the cover member 54 in such a manner as to rotate in an interlocking fashion via a gear not shown, and one end of the transfer tape 1 which is wound on the supply bobbin 51 is connected to the take-up bobbin 52 via the transfer head 53.

In addition, when the coating film transfer device 50 is moved forwards or backwards in such a state that the transfer head 53 is pressed against the surface of a transfer object, the transfer tape 1 is pulled so that a fresh transfer tape 1 is fed out of the supply bobbin 51, a coating film layer 7 is separated from the base material layer 2 so as to be allowed to adhere to the surface of the transfer object, and the base material layer 2 is taken up onto the take-up bobbin 52 which is rotating in conjunction with rotation of the supply bobbin 51.

Next, an advantage of the invention will be described. In a case where a sheet is shredded into tapes for fabrication of transfer tapes 1, in the case of the sheet being a sheet on which a conventional pattern is printed in which alphabetical characters are arranged regularly as is shown in FIG. 4A, in the event that a cutting position falls between a line of characters and a line of characters as is shown in FIGS. 4B, 4C, there is caused a problem that blank areas are increased in the vicinity of the cutting positions or where the sheet is shredded, and hence, depending upon where to cut, different opacifying effects result. In addition, since the characters are arranged regularly in the horizontal direction, in the event that small characters or the like which are written on the transfer object are positioned between the alphabetical characters, there has been a possibility that those characters could be read.

According to the transfer tape 1 of the embodiment, however, by adopting for the shape of the pattern printed on the transfer tape the pattern in which the alphabetical characters are arranged inclined obliquely, even in the event that the sheet is shredded into tapes in the horizontal direction when fabricating transfer tapes 1, there is caused no such situation that the cutting position falls between the lines of alphabetical characters. Consequently, there is caused no difference in opacifying effect. In addition, even in the event that small characters written on the transfer object fall between the alphabetical characters, since blank areas do not continue in the horizontal direction, even though one or two characters can be read, there is caused no such situation that all the sentence can be read, thereby making it possible to enhance the opacifying effect.

In addition, in the embodiment, while the anchor layer 3 is provided which contains the white pigments and the transfer tape 1 is made to be fabricated by laminating the anchor layer 3 and the opacifying layer 4, the transfer tape 1 may be made to be fabricated by only the base material layer 2 and the opacifying layer 4 without using the anchor layer 3, so that the transfer tape 1 can also be used as an individuals' personal information protection tape which can simply conceal or opacify characters or the like which are written on the transfer object. Additionally, as the shape of pattern used, alphabetical characters or Japanese KATAKANA characters which are different in size can be arranged at random to obtain the same advantage.

The invention is not limited to the embodiment that has been described heretofore and hence can be changed or modified freely without departing from the spirit and scope thereof.

1. A transfer tape comprising a base material layer and a: coating film layer and adapted to transfer the coating film layer on to a surface of a transfer object by a coating film transfer device, wherein
the coating film layer comprises a pattern layer on which an opacifying pattern shape is printed, and wherein
a pattern shape of the pattern layer is such that a plurality of alphabetical characters are arranged obliquely inclined relative to a longitudinal direction of the transfer tape.

2. A transfer tape as set forth in claim 1, wherein
the coating film layer comprises an ink layer where pigments are contained in a medium, the ink layer and the pattern layer being laminated in such a manner that the ink layer is positioned on a front surface side, while the pattern layer is positioned on a rear surface side of the coating film layer.
